(19) United States
(12) Patent Application Publication
(10) Pub. No.: US 2010/0148463 A1
(43) Pub. Date: Jun. 17, 2010

(54) Mechatronic suspension system and method for shock absorbing thereof

(75) Inventors: Fu-cheng Wang, Taipei (TW); Hsiang-an Chan, Kaohsiung (TW)

Correspondence Address: BACON & THOMAS, PLLC, 625 SLATERS LANE, FOURTH FLOOR, ALEXANDRIA, VA, 22314-1176, US

(73) Assignee: National Taiwan University, Taipei (TW)

(21) Appl. No.: 12/379,899

(22) Filed: Mar. 4, 2009

(30) Foreign Application Priority Data
Dec. 12, 2008 (TW) 097148362

(51) Int. Cl. B60G 17/00; F16H 1/24; F16F 15/03

(52) U.S. Cl. 280/124.101; 74/424.82; 188/267

(57) ABSTRACT

The invention provides a mechatronic suspension system and a method for shock absorbing thereof. The invention applies the analogies between mechanical and electronic networks to propose a mechatronic suspension system, which combines a ball-screw inerter and a permanent magnet electric machinery, such that the complicated network structure can be realized through the combination of mechanical and electronic networks. The mechatronic suspension system is connected to two terminals, and consists of the inerter mechanism, the permanent magnet electric machinery and the feedback circuit. The inerter mechanism is connected to the terminals to transfer the linear motion into the rotational motion. The permanent magnet electric machinery is connected to the inerter mechanism to generate a corresponding voltage. And the feedback circuit is connected to the permanent magnet electric machinery to provide suitable system impedance and to generate a feedback force.

### BACKGROUND OF THE INVENTION

1. Field of the Invention

The invention relates to a suspension system and a method for shock absorbing thereof, more particularly to a mechatronic suspension system and a method for shock absorbing thereof.

2. Description of the Prior Art

When the vehicle is driven on the road, it suffers from various shock and impact from ground and driving conditions, wherein part of shock and impact can be absorbed by the tires, and most of shock and impact must be absorbed by the suspension system installed between the tires and car body. It can prevent the parts of car body from damage, and make the passengers feel comfortable. Thus the suspension system not only can absorb the outside shock and impact, but also can have direct and positive influence on the stability and manipulation of driven vehicle.

As for the major design and application of the vehicle suspension system at present, the mechanical devices such as the spring device, air cushion device, and hydraulic device are all adopted. However, the performance of the above-mentioned suspension systems is not satisfied for the industrial requirement. Thus the above-mentioned traditional vehicle suspension system still has the shortcomings.

Inerter mechanism is a mechanical network component, wherein the mechanical system can be correspondent to the electronic system completely, and is widely used in the system design for vehicle, motorcycle, train and building etc., in order to raise their performance. As for the example of above-mentioned suspension systems, if the inerter is used in the suspension design, the fixed structure or non-fixed structure can be adopted. The fixed structure can carry out the optimal design of structural parameters corresponding to the requirement of specific performance. The non-fixed structure uses the Linear Matrix Inequalities (LMI) to optimize the transfer function or the system impedance, and then cooperates with the network synthesis to find out the corresponding structures. It was illustrated that system performance can be further improved by allowing higher order and complex system impedance. However, the network synthesis for high-order impedance can be very complicated and the volume of mechanical devices is too large to install in the vehicle chassis actually.

Therefore, in order to provide better and more effective vehicle suspension apparatus, it is necessary to research and develop a novel suspension device, to raise the efficiency and reduce the manufacturing time and manufacturing cost.

### SUMMARY OF THE INVENTION

The purpose of the invention is to provide a mechatronic suspension system and a method for shock absorbing thereof, in order to improve the technique of existing suspension systems, and raise the shock absorbing effects.

The mechatronic suspension system apparatus of the invention is connected to two terminals, and consists of an inerter mechanism, a permanent magnet electric machinery and a feedback circuit. The inerter mechanism is connected to the terminals to transfer the linear motion into the rotational motion. The permanent magnet electric machinery is connected to the inerter mechanism to generate a corresponding voltage. And the feedback circuit is connected to the permanent magnet electric machinery to provide suitable system impedance and to generate a feedback force.

According to another scope of the invention, the method for shock absorbing proposed by the invention comprises: Using the inerter mechanism to transfer the linear motion into rotational motion, using the permanent magnet electric machinery to generate a corresponding voltage, and using the feedback circuit to provide suitable system impedance and to generate a feedback force.

The invention applies the corresponding relation of mechanical/electronic networks to propose a mechatronic suspension system. It combines a ball-screw inerter and a permanent magnet electric machinery, such that the complicated network structure can be realized through the combination of mechanical and electronic networks.

In practical application, the invention can be used in vehicle and motorcycle industry, train industry, building industry, shock absorbing systems, precision machinery, and optical shock absorbing desks etc. Its technical feature is to combine the mechanical impedance and electronic impedance to form a mechatronic system. The electronic impedance is converted to equivalent mechanical impedance through the ball-screw and direct current motor, such that the complicated network structure can be realized in reality.

The invention can be achieved through the ball-screw, or the conversion of linear-rotational physical quantity can be completed through the rack-and-pinion or the hydraulic way.

The invention can be carried out by the direct current motor. The invention can also use active electrical networks to reach the design of active mechatronic suspension systems.

The traditional inertial performance increment is only limited to the vehicle systems of high-stiffness, such as sport cars and F1 racing cars. The invention can be expanded to other vehicle systems.

The mechatronic suspension system proposed by the invention can improve the performance of vehicle systems of low-stiffness, such as sedans, such that its scope of application is more extensive.

Therefore, the advantage and spirit of the invention can be understood further by the following detail description of invention and attached Figures.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates the block diagram of mechatronic suspension system of the invention.

FIG. 2A shows a preferred embodiment of the mechatronic suspension system of the invention.

FIG. 2B shows a preferred embodiment of the mechatronic suspension system of the invention.

FIG. 3 shows a preferred embodiment of the mechatronic suspension system and method for shock absorbing of the invention.

### DESCRIPTION OF THE PREFERRED EMBODIMENT

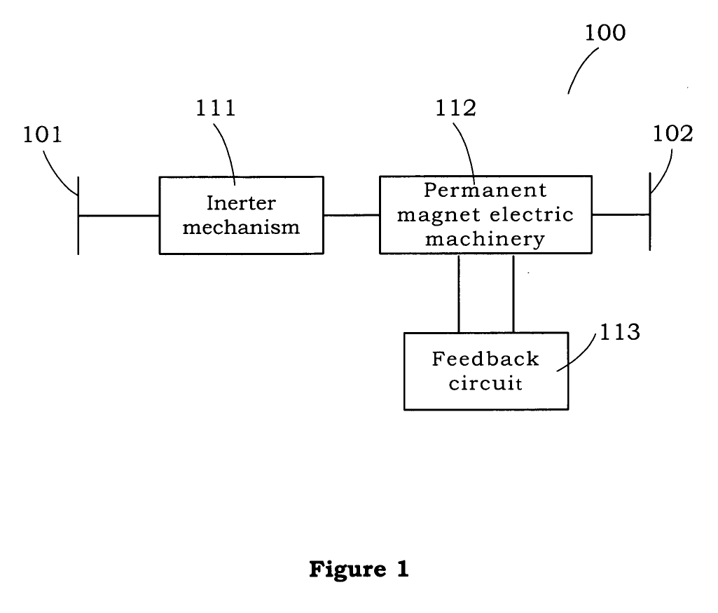

FIG. 1 illustrates the block diagram of the whole mechatronic suspension system apparatus of the invention. The mechatronic suspension system 100 composes of an inerter mechanism 111, a permanent magnet electric machinery 112, and a feedback circuit 113. The mechatronic suspension system 100 is connected to two terminals, which are the first terminal 101 and the second terminal 102. The mechatronic suspension system 100 can be applied to various fields, such as the vehicle and motorcycle industry, train industry, building industry, shock absorbing systems, precision machinery, and optical shock absorbing desks etc.

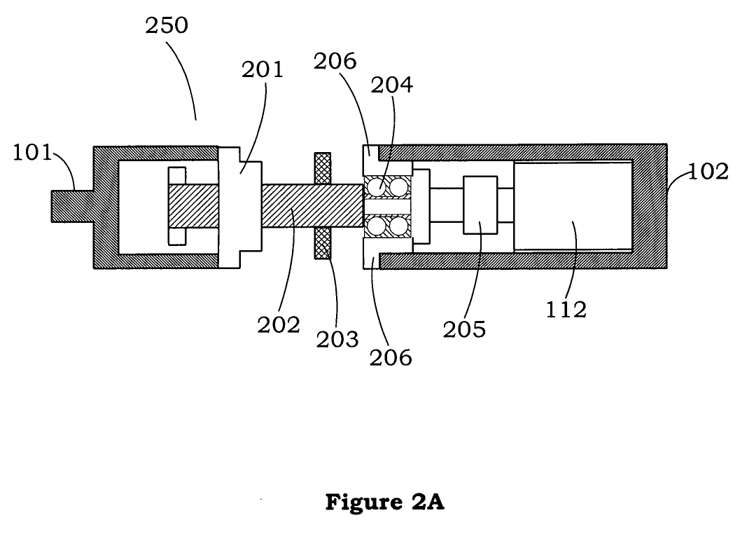

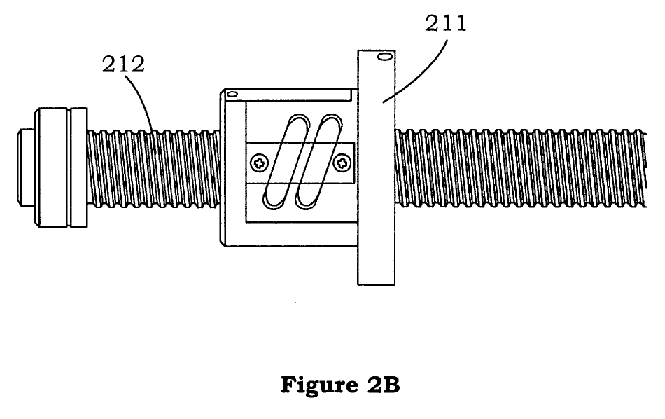

As shown in FIG. 2A, the inerter mechanism (ball-screw inerter) 250 also composes of the nut 201, screw 202, flywheel 203, bearing 204, coupling 205, and bearing socket 206. The nut 201 is fixed on the first terminal 101 with screw 202. The screw 202 is coupled with flywheel 203 and bearing 204. The bearing socket 206 is used to fix the bearing 204. The coupling 205 is coupled to one end of permanent magnet electric machinery 112. The wheel 203 on screw 202 can adjust inertance of the inerter mechanism 250 to change the relative inertia of the system between the first terminal 101 and the second terminal 102.

As shown in FIG. 2B, the inerter mechanism 250 is a mechanical device which can transfer the linear physical quantity into the rotational physical quantity or vice versa. Compared to similar device such as the rack-and-pinion device, it has the advantages of low friction, small backlash, and high conversion efficiency etc. In the invention, the relative displacement is generated between the nut 211 of ball-screw 212 and the bearing socket 206 to rotate the axle of permanent magnet electric machinery 112 coupled to ball-screw 212 and to generate a corresponding output voltage, in order to provide suitable system impedance and to generate a feedback force through the design of the electronic network. The rack-and-pinion or hydraulic way can also be used to realize the conversion of linear-rotational physical quantity, or directly provide linear force. As for the ball-screw 212 device, the steel balls are placed on the contact surface between the nut 211 and the ball-screw 212 to form the rotational friction instead of the sliding friction between the nut 211 and the ball-screw 212. Therefore, friction force is small. And due to more precision fabrication processes, the backlash is very small and can be further eliminated by pre-loadings.

As shown in FIG. 1, the permanent magnet electric machinery 112 is a permanent magnet direct current motor generator. The induced voltage is generated from the angular velocity of the mechanical part of permanent magnet electric machinery 112, such that the mechanical energy is converted into the electric energy. The permanent magnet electric machinery 112 is coupled to the second terminal 102.

As shown in FIG. 1, the feedback circuit 113 can be used to adjust the current generated by the permanent magnet electric machinery 112. The feedback circuit 113 can be integrated with the permanent magnet electric machinery 112. The permanent magnet electric machinery 112 is coupled to the second terminal 102. The feedback circuit 113 composes of a circuit impedance and a negative impedance converter (NIC) circuit, and the negative impedance converter circuit can be used to eliminate the impedance and conductance in the permanent magnet electric machinery 112 to simplify the electronic network design.

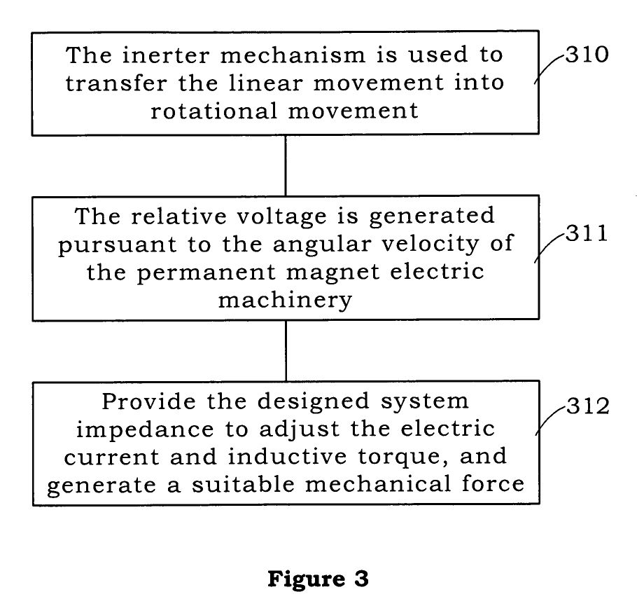

FIG. 3 shows a preferred embodiment of the mechatronic suspension system and method of the invention, and the method for shock absorbing is described as follows:

In Step 310, the inerter mechanism is used to transfer the linear movement into the rotational movement. In the mechatronic suspension system 100, when the relative motion is generated between the first terminal 101 and the second terminal 102, the mechatronic suspension system 100 can use the inerter mechanism 111 to transfer the linear movement into the rotational movement. Namely when the relative linear motion is generated between the first terminal 101 and the second terminal 102, the ball-screw 204 of inerter mechanism 111 will rotate the axle of permanent magnet electric machinery 112 through the couple 205.

In Step 311, the relative voltage is generated pursuant to the angular velocity of the permanent magnet electric machinery. Namely the permanent magnet electric machinery 111 will generate a voltage according to the angular velocity provided by the inerter mechanism 112, wherein the voltage is corresponding to the angular velocity. When the angular velocity is larger, the higher is the voltage. And when the angular velocity is smaller, the lower is the voltage. Namely the angular velocity has the proportional relationship with respect to the voltage.

In Step 312, the system impedance is designed to provide the feedback force. Namely the feedback circuit 113 in the mechatronic suspension system 100 can provide the designed system impedance in accordance with the voltage, and adjust the electric current and inductive torque, and generate suitable mechanical force or the equivalent mechanical force to reach the performance requirement of system shock reduction and shock absorbing.

Therefore summarized from the above-mentioned description, the mechatronic suspension system has a ball-screw inerter at one end. When the relative displacement is generated between the nut and the bearing socket, the axle of permanent magnet electric machinery coupled to ball-screw inerter will be rotated to generate a corresponding voltage. In order to provide suitable system impedance and to generate a feedback force through the design of electronic network, the equivalent mechanical force will be generated through the design of outside electronic network impedances to reach the performance requirement of system shock reduction.

The invention uses the inertial principle to make up the mechanical network component. The mechanical system can be correspondent to the electronic system completely, and is widely used in the system design of vehicle, motorcycle, train and building etc., in order to raise their performance. The invention can be realized through the ball-screw, or the conversion of linear-rotational physical quantity can be realized through the rack-and-pinion or the hydraulic way.

Thus, summarized from the above-mentioned description, a preferred embodiment of the invention applies the corresponding relationship of mechanical/electronic networks to propose a mechatronic suspension system. The ball-screw inerter and the permanent magnet electric machinery are combined to realize the complicated network structure through the combination of mechanical and electronic networks.

It is understood that various other modifications will be apparent to and can be readily made by those skilled in the art without departing from the scope and spirit of this invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to which this invention pertains.

What is claimed is:

1. A mechatronic suspension system apparatus, comprising:
an inerter mechanism for transferring a linear motion into a rotational motion;
a permanent magnet electric machinery for connecting to the inerter mechanism to generate a corresponding voltage according to an angular velocity of the rotational motion; and
a feedback circuit for providing a designed system impedance and adjusting an electric current and an inductive torque, and generating a suitable mechanical force to form the mechatronic suspension system apparatus.

2. The apparatus according to claim 1, wherein the inerter mechanism comprises a ball-screw inerter mechanism.

3. The apparatus according to claim 2, wherein the ball-screw inerter comprises:
a nut;
a screw;
a flywheel for adjusting inertance of an inerter mechanism and being coaxial with the screw;
a bearing;
a bearing socket to fix the bearing; and
a coupling coupled to one end of a permanent magnet electric machinery to form the inerter mechanism.

4. The apparatus according to claim 1, wherein the permanent magnet electric machinery comprises a permanent magnet direct current motor generator.

5. The apparatus according to claim 1, wherein the feedback circuit comprises:
a circuit impedance; and
a negative impedance converter circuit.

6. A method for using mechatronic suspension system apparatus, comprising:
using an inerter mechanism to transfer a linear motion into a rotational motion;
using a permanent magnet electric machinery to generate a corresponding voltage according to an angular velocity of the rotational motion; and
using a feedback circuit to provide a designed system impedance, adjusting an electric current and an inductive torque, and generating a suitable mechanical force.

7. The method according to claim 6, wherein the inerter mechanism comprises a ball-screw inerter mechanism.

8. The method according to claim 7, wherein the ball-screw inerter comprises:
a nut;
a screw;
a flywheel for adjusting inertance of an inerter mechanism and being coaxial with the screw;
a bearing;
a bearing socket for fixing the bearing; and
a coupling coupled to an end of a permanent magnet electric machinery to form the inerter mechanism.

9. The method according to claim 6, wherein the permanent magnet electric machinery comprises a permanent magnet direct current motor generator.

10. The method according to claim 6, wherein the angular velocity comprises a proportional relationship with respect to the voltage.

11. The method according to claim 6, wherein the feedback circuit comprises:
a circuit impedance; and
a negative impedance converter circuit.

12. A ball-screw inerter comprises:
a nut;
a screw;
a flywheel for adjusting inertance of an inerter mechanism and being coaxial with the screw;
a bearing;
a bearing socket to fix the bearing; and
a coupling coupled to an end of permanent magnet electric machinery to form the inerter mechanism.

13. A method for shock absorbing, comprising:
using an inerter mechanism for transferring a linear motion into a rotational motion;
using a permanent magnet electric machinery to generate a corresponding voltage according to an angular velocity of rotational motion; and
using a feedback circuit to provide a designed system impedance, adjusting an electric current and inductive torque, and generating a suitable mechanical force.

14. The method according to claim 13, wherein the inerter mechanism comprises a ball-screw inerter mechanism.

15. The method according to claim 14, wherein the ball-screw inerter comprises:
a nut;
a screw;
a flywheel for adjusting inertance of an inerter mechanism and being coaxial with the screw;
a bearing;
a bearing socket to fix the bearing; and
a coupling coupled to an end of permanent magnet electric machinery to form the inerter mechanism.

16. The method according to claim 13, wherein the permanent magnet electric machinery comprises a permanent magnet direct current motor generator.

17. The method according to claim 13, wherein the angular velocity comprises a proportional relationship with respect to the voltage.

18. The method according to claim 13, wherein the feedback circuit comprises:
a circuit impedance; and
a negative impedance converter circuit.
